(19) United States
(12) Patent Application Publication
(10) Pub. No.: US 2004/0153427 A1
(43) Pub. Date: Aug. 5, 2004

(54) Device for generating selection structures, for making selections according to selection structures, and for creating selection descriptions

(76) Inventors: Hardi Hungar, Wardenburg (DE); Bernhard Steffen, Dortmund (DE); Tiziana Margaria-Steffen, Dortmund (DE)

Correspondence Address: BAKER & DANIELS, 205 W. JEFFERSON BOULEVARD, SUITE 250, SOUTH BEND, IN, 46601, US

(21) Appl. No.: 10/468,855

(22) PCT Filed: Feb. 21, 2002
(86) PCT No.: PCT/DE02/00627

(51) Int. Cl. G06F 17/00; G06N 5/02

(52) U.S. Cl. 706/47

(57) ABSTRACT

The invention relates to a device for selecting data elements that contains a selection description device for creating a selection description data element, a generator device, which generates a selection structure data element from the selection description data element, and contains a selection device, which makes a selection from the input data elements when an inquiry data element is present. Selection description data elements can be created by non-electronic data processing specialists. The generation of the selection structure data element is of significant importance. Due to its nature, the selection device can be designed with a low level of complexity, can be operated while detached from the other devices, and can rapidly make selections. The invention can be used in many areas of application in the field of information technology, particularly in embedded systems, in the personalization of web pages, in e-commerce systems, and in targeted marketing.

### BACKGROUND OF THE INVENTION

The invention relates to an apparatus for creating a selection description data element and to an apparatus for producing a selection structure data element from a selection description data element, and to an apparatus for selecting output data elements on the basis of a selection structure element and a query data element, and to combinations of additions to such apparatuses.

Many different applications in information technology involve making a decision from a prescribed set of data elements in a current decision situation. In this context, the set of data elements can also comprise digitized numbers. Information technology offers many kinds of solutions to such problems. One component is computer-related formulation of the selection, which is done using programming languages or using descriptions of selection devices and the associated tools.

There are essentially two different styles in which this can be done. First, in the form of precise individual instructions whose execution is precisely stipulated. This style is often called operational. Known forms are programs in a language such as C. An advantage of this description form is that compilation allows code which operates very efficiently to be produced. A drawback is that the programming capabilities required for creation necessitate specialists, and users cannot develop such programs. In addition, the actual effect of a program is normally not easy to comprehend, and the described function can often vary greatly in the case of small changes to the program. This makes creating and changing the description complicated. The opposite style, often called predicative, instead describes properties of the desired results and prescribes the flow of calculation only indirectly. The advantage is that users can deliver the description in special areas with appropriate support. In this case, however, a drawback is that the description usually takes much longer to implement than when operational descriptions are used.

Users can create only very simple operational descriptions. In addition, more complex descriptions are often incorrect. In the case of predicative descriptions, extended implementation times are problematical in many respects. They increase the expense of technical solutions to tasks which need to be carried out under, real-time demands or even make certain object unachievable. Besides many other areas, this all relates to embedded control systems, data networks, data filters and particularly also Internet services, for example.

### SUMMARY OF THE INVENTION

It is an object of the invention to be able to make selections quickly and using inexpensive means and to allow users who are not EDP experts to describe selections. The term selection can also cover ascertainment of a numerical variable.

The invention achieves this object by means of the subjects covered in patent claims 1-48.

The apparatuses in accordance with claims 1-12 relate to the creation of selection description data elements. The apparatuses in accordance with claims 13-21 prepare the selection through creation of a selection structure data element such that they can be performed by the apparatuses in accordance with claims 22-30. Claims 36, 37 describe additions to the apparatuses for creating the selection description data elements which permit an open view of the effect of the selection description data element at the creation time. The actual response can be ascertained by the logging devices in accordance with claims 38, 39, 40.

One particular advantage of the apparatuses in accordance with claims 1-12 is the possibility for even users who are not EDP experts to describe selections according to a precise target and to have a good overview of the description and to maintain it well. Merely the description with rules and, in particular, also the additions in accordance with claims 36, 37 allow the user to convert his ideas into the description of a precisely targeted selection.

The apparatuses in accordance with claims 13-21 prepare the selection process by creating a selection structure, with the consequence that the apparatuses in accordance with claims 22-30 can quickly make a selection even when complex selection functions are involved. This is a considerable advantage over existing solutions, which are not able to evaluate complex, selection functions at similar speeds or else to evaluate them at all. In addition, the apparatuses in accordance with claims 22-30 are less expensive than conventional apparatuses for this purpose.

These advantages allow the invention to be used advantageously for a large number of, purposes and in a large number of contexts. The type and content of the application influence the form of the results and the design of the selection structure data element, which can also be a combination of a plurality of more elementary data elements. One fundamental application type relates to selections from a set of data objects which are stored in; databases. In this case, the preparation allows time consuming database queries at the selection time to be avoided completely or to be reduced to one or a few. This means that corresponding applications can be implemented without expensive database servers or without database servers at all. One specific application context of the invention is personalizing web presentations and that, of personalizing e-commerce systems. In this case, the speed of evaluation is revealed to particular advantage, since servers need to process user queries in real time and can be designed to greater benefit using the invention.

In general, the invention is suitable for describing and evaluating functions

whose arguments can be described by argument profiles and whose results can be described by result profiles,

where

the argument profiles are discrete values,

the result profiles are discrete values,

the conversion from argument to argument profile and the conversion from result profile to result are performed by apparatuses in connection with the invention.

In the instance of application, the argument and the argument profile can be identical. There is then no conversion from argument to argument profile. In the instance of application, the result profile and the result can be identical. There is then no conversion from result profile to result.

Using binary representation, for example, it is also possible to regard numerical variables and elements which contain numerical variables as discrete values and thus to include them in the term of discrete values. Another way of introducing discrete profiles for functions which involve numerical variables is to describe numerical variables using properties or to represent them on an approximentive basis using elements of discrete value ranges. Another way is to represent numerical variables using algebraic terms. In one among several other application situations, the possible results are elements in a database, and the profile of a possible result is an access term for the database which delivers the result upon access.

In claim 13, the query data element comprises the profile of the argument. The selection description data element describes the function which assigns result profiles to argument profiles. The input data elements contain all possible result profiles. The result profiles assigned to the argument profiles by the function are the output data elements. The input data elements can be available in explicitly enumerated form, but can also be implicitly defined as a set of data elements, such as bit arrays of a fixed length which represent integers.

Various forms of such functions are as follows:

Assignments: each element in a set of objects needs to be assigned an object from a further set.

Weightings: on the basis of argument, objects in a set need to be weighted.

Selections: on the basis of argument, objects need to be selected from a set.

In specific terms, such functions can have a variety of purposes. One example of a selection is when available spaces for banner advertisement with banners in a web page need to be selected from an available set at the display time. This selection can be based, in particular, on a weighting which assigns numerical values, to the various banners on the basis of the situation and subsequently selects with the maximum weighting, for example.

A weighting can also be used, by way of example, when risk assessment on the basis of the factors known about a situation is involved. It is thus possible, by way of example, to produce, an apparatus which decides about the acceptance of a credit card for a financial transaction using a weighting apparatus which is achieved using the invention.

Personalization, e.g. customer-specific compilation and/or modification of a web presentation, can be regarded as assignment.

Functions in quite different application areas are, likewise covered by these generic terms, however. These include, by way of example, control systems for technical processes, as detailed in claims 28 and 29. For example, an engine control system in a car needs to perform control operations on the basis of user actions and the state of the drive components. The decision as to which actions need to be prompted depends on discrete observations, and the actions themselves need to be selected from a discrete set. Execution of the actions themselves can involve calculations on continuous values.

The application to the invention makes the selection regarding which actions need to be performed. This can be done, even if the actions have numerical parameters. In one implementation option, such parameters are denoted discretely; for example by an access term for a family of characteristic curves or for numerical argument components. Calculations needing to be performed when executing an action can be transferred to the form of the invention [lacuna] connected apparatuses.

Functions can be described by closed-loop control systems such as can be created with apparatus in accordance with claims 1-12.

A rule can be used to relate query data elements and input data elements. The use of a numerical component allows the strength of such a relationship to be expressed. A numerical weighting for query data elements can likewise be expressed by a numerical component, as can a weighting for input data elements. A binary-value condition part for query data elements and a binary-value conclusion part for input data elements in a rule, as cited in claim 3, can be used to denote the set of the pairs of query data elements and input data elements to which the respective conditions apply.

Individual rules can., be linked in accordance with claim 1 to form closed loop control systems. Notable types of link are as follows:

The cumulation cited in claim 4, where for each pair of query and input data elements the numerical components of those rules which denote this pair using a condition part and a conclusion part are linked. Hence, the expressed strength of the relationship of the pair components is cumulated. Cumulation can be performed using any arithmetic operator, one specific form being addition.

The prioritization cited in claim 7, which allows an expression of which rule is to apply when more than one can be used. In one specific form, the prioritization can be formulated using numerical rule components.

The serial connection cited in claim 5, where results of rule evaluations deliver or modify arguments for later rules. In one specific form, actions also belong to the possible results of upstream rules, which need to be implemented before the downstream rules are applied.

In addition, there can be other links between rules. The links can be applied to individual rules and to sets of rules and to rules which have already been linked. Rules which occur in a, selection description data element do not all have to relate to the respective same types of objects in condition parts and the same types of objects in conclusion parts. Serial implementations, in particular, are essentially based on greater freedom.

The special form of selection description data elements in claim 8 relates to selections of output data elements which comprise more than one component, the selections being described in at least two parts which are connected in succession. In upstream parts, a weighting for output data elements for individual components is described using cumulatively linked rules. In a downstream part, the weighting for the component data elements is used in further rules. Selection description data elements corresponding to this form are suitable for a wide variety of applications. In particular, selections for missing components in web pages can be formulated in this manner. In one specific form, data elements for all the individual components of the output are weighted with cumulation by means of addition in upstream parts. A downstream part takes into account interdependencies between the individual components, for example the avoidance of conflicts.

The inclusion of elements in, the rules which refer to previous selections, in accordance with claim 9, makes it possible to describe selections, so that the results of later selections can be matched to the results of earlier ones. One utilization option involves the avoidance of conflicts. Another utilization option involves complementing the earlier results with the current selection. One example of application is the description of a selection of advertizing components, so that a desired succession of advertizing components appear on successively retrieved web pages which are consequently presented to the caller in order.

Macros in accordance with claim 11 are description data elements which denote partial data elements of selection; description data elements. The occurrence of a, macro in a selection description data element represents the denoted partial data element. One benefit of macros is that, the use of macros means that selection description data elements are in many cases represented in a shorter form than when macros are not used. Another benefit is that selection description data elements can be represented more clearly by using macros. One specific form of macros are macros which denote selection description data elements. In forms of an apparatus in accordance with claim 11, macros can be designed such that a macro occurs in a plurality of selection description data elements.

Selection description data elements can be specified in apparatuses in accordance with claim 12 such that parts of rules apply for more than one rule without new occurrences of the rule parts being present in the selection description data element for each of the rules for which they apply. One form of such multiple applicability is that, with a plurality of rules where a part which describes query data elements is common to these rules, this part appears only once in the selection description data element, and the description of the individual rules to which this part is common is respectively completed by specifying the addition. In another form, a part with multiple applicability can be used if descriptions of output data elements are the same in a plurality of rules.

Claims 13 to 30 and 31 to 35 describe apparatuses for evaluating selection description data elements. The evaluation comprises two steps. One step is performed by a generator device in accordance with claim 13. The input to a generator device contains a selection description data element. The output from a generator device contains a selection structure data element, which, makes a selection, in the form of an association diagram conglomerate.

An association diagram is a finite diagram for assigning output elements to input elements with two types of nodes, internal nodes and terminating nodes, where

internal nodes are the starting point for edges directed to other nodes,

the edges have associated properties of the input elements,

terminating nodes denote sets of output elements,

so that

each internal node describes that function which assigns to an input element those output elements which are denoted by those terminating nodes which can be reached via paths, where the input element has all the properties which are associated with the edges on the path.

An association diagram conglomerate contains an association diagram or a set of association diagrams which are linked to one another,

where

parallel connection and serial connection belong to the usable link types which can also both be used within the conglomerate,

in the case of an association diagram link of the parallel-connection type, the output elements of the linked association diagram can be produced together from the output elements of the individual diagrams by means of an element link,

in the case of an association diagram link of the serial-connection type output elements of upstream diagrams go into the input elements of downstream diagrams.

The links of the parallel-connection type include the parallel placement of the output elements of the linked association diagrams in a tuple, the association diagrams being applied to the same input element in each case.

Association diagrams can be minimized by combining nodes which describe the same function.

Association diagrams and association diagram conglomerates describe functions. The description of a function is approximative if it does not describe the same selection as the function in every case, but for an overwhelming majority of the query data objects. Alternatively, a description is approximative if the association is based on a numerical weighting and the association described chooses those output data elements whose weighting differs by little in the overwhelming majority of cases.

Cumulation is the combination of a plurality of numerical weighting functions to form a single one, with the overall weighting being obtained in every single case through the application of an associative and communicative link to the set of individual weightings. One particular form of cumulation uses addition as the link.

The work of the generator device in accordance with claim 13 comprises converting a selection description data element into a selection structure data element which describes the function which is described by the selection description data element. This is done without the need for a specific query data element to be available. Conversion by the generator can be carried out before the described function is performed. Association diagram conglomerates contained in the selection structure data element can be quickly evaluated when the argument profile from the query data element is available.

The extension, in accordance with claim 14, of the generator device is able to produce selection structure data elements which are smaller than those which describe the function described in the selection description data element and describe the function approximatively. The results of this generation can be controlled by control input elements. Methods which can be used for reduction and approximation comprise

combining nodes in association diagrams which do not

describe the same function,

rounding of weightings,

limitation of the accuracy for representing weighting functions,

reduction of the result space of functions.

reduction of the result space of parts of functions.

The advantage of extension is the reducibility of the selection structure data elements. This allows generator apparatuses to be implemented less expensively, selection apparatuses to be implemented less expensively, any apparatuses for connecting generator apparatus and selection apparatus to be implemented more beneficially or to be operated less expensively, the processing speed of generator apparatuses to be increased, and the processing speed of selection apparatuses to be increased.

The method of approximation through calculation for cumulative numerical weighting functions with accuracy controlled by control input elements is, implemented in apparatuses in accordance with claim 15.

Generator apparatuses in accordance with claim 16 are capable of approximation for selection description data elements which describe serial connection of functions, by virtue of the results of the upstream stage in a serial connection being approximated. One form of this approximation relates to cases where the upstream stage is at least partly based on, weighting and the weightings for the first stage do not go into the input data elements of the downstream stage for all input data elements which are to be weighted. In one specific form, a selection of the weighted input data elements which go into the downstream stage is made such that a prescribed number is selected which is characterized in that data elements with high weightings are given priority over those with lower weightings and the profiles of the data elements in the selection differ in many values.

The apparatus in accordance with claim 17 can be operated such that, after a selection structure data element has been generated from a selection description data element, a change in the selection description data element can involve generation of a selection structure data element which corresponds to the change without carrying out all the steps would necessary in the case of regeneration. In this context, the apparatus proceeds such that it stores association diagram conglomerates produced when the selection structure data, element was generated and modifies them in line with the change, in order subsequently to derive the changed selection structure data element therefrom. In one specific form, when the change in the selection description data element relates to rules linked to cumulation, a change can be, incorporated by cumulating differential rules.

The apparatus in accordance with claim 18 uses association diagrams minimized in association diagram data structures and association diagram conglomerates and uses routines and tools for processing them.

The apparatus in accordance with claim 19 uses association diagrams minimized in association diagram data binary degree of branching and uses routines and tools for processing them. Binary degree of branching means, that two edges come from internal nodes in the diagram.

Apparatuses in accordance with claim 20 use, in association diagram data structures and association diagram conglomerates, association diagrams which are referred to by the abbreviation ADD, standing for “Algebraic Decision Diagram”. These association diagrams are also known by the abbreviation MTBDD, standing for “Multi-Terminal Binary Decision Diagrams”. These data structures are described in I. Bahar, E. Frohm, C. Gaona, G. Hachtel, E. Macii, A. Padro, F. Somenzi: “Algebraic Decision Diagrams and their Applications”, Journal of Formal Methods of Systems Design, Vol. 10, No 2/3, pp. 171-206, 1997. In one particular form, the apparatus for handling ADDs uses the CUDD tool, which has been developed and is being developed further under the supervision of Fabio Somenzi at the Colorado State University.

The apparatus in accordance with claim 21 generates from selection description data elements, where the selection is described by a weighting for the input data elements, so that, input data elements with the highest possible weighting can be selected when a query data element is available a selection structure data element which contains an association diagram, where the edges are associated with properties of the query data element, and the terminating nodes denote the output data elements.

The apparatus in accordance with claim 22 makes the selection by reverting to the selection structure data element when the query data element is available. The selection device can be operated separately from generating devices in accordance with claim 13 to 21. In one specific form, an apparatus jointly contains the selection device and apparatuses which produce the query data element from the available argument. One particular advantage of the apparatus 4 in accordance with claim 22 is, besides the speed, the ability to be limited to simple operations.

The apparatus in accordance with claim 23 has access to at least two selection structure data elements. In operation, a selection structure data element can be replaced without interrupting operation. The selection structure data element accessed by the apparatus for making the selection can be chosen. Thus, the apparatus can be changed over to a new selection structure data element without interrupting ongoing operations.

The apparatus in accordance with claim 24 can be controlled such that interim results from a selection operation are available for a later selection operation. This means that it is possible to reduce the time requirement for a later selection operation.

The apparatus in accordance with claim 25 can be influenced by control inputs such that the same selection is not always made when the query data element and the selection structure data element are the same, but rather different selections are made on a random basis. In one specific form, the width of variation of the selection can be controlled. In another specific form, if the selection is based on a weighting, the likelihood of an output data element being selected increases with its weighting.

The apparatus in accordance with claim 26 permits the results of the selection to be altered without changing the selection structure data element. In one specific form, this is done by virtue of the selection structure data element not containing the output data elements but rather only descriptor data elements. The output data elements are associated with the descriptors in a further data element, which can be altered.

The apparatus in accordance with claim 27 performs actions during a selection which relates to data elements apart from the selection structure data element. In one specific form, these actions are denoted by interim results during the selection. In one specific form, these actions alter the query data element. In one specific form, the performance of an action comprises access to a data store from which data elements are taken which are used to alter the query data element. In one specific form, alteration of a query data element comprises complementing the query data element.

The apparatus in accordance with claim 28 comprises an apparatus in accordance with claim 22 to 27 and an apparatus which converts output data elements into actions denoted thereby. In one specific form, an action comprises the sending of a message. In another specific form, an action comprises the activity of a physical actuator. In one specific form, a physical actuator is an apparatus which performs movements.

The apparatus in accordance with claim 29 is contained in a control apparatus for a physical or chemical process. In one specific form, this is a purely physical process. In one specific form, the process is monitored. In another specific form, the process is also controlled. For a selection, the query data element contains a description, of the state of the process which is to be controlled. The selection data element contains a description of an action by the control apparatus. In one specific form, the selection is made cyclically.

The apparatus in accordance with claim 30 is used to calculate a weighting function. The output data element calculated for a query data element denotes the weighting of the argument denoted by the query data element. In one specific form, the output data element comprises numerical components.

The apparatus in accordance with claim 31 comprises a generation apparatus and a selection apparatus, with selection structure data elements produced by the generation apparatus being used by the selection apparatus. In one specific form, the generation apparatus and a selection apparatus are apparatuses which operate separately from one another. In another specific form, the apparatus contains an apparatus which undertakes actuation of the generation and selection apparatuses.

The apparatus in accordance with claim 32 is characterized in that the generation apparatus can operate offline and the selection apparatus can operate online. Operating offline means that the generation apparatus does not need to be active during the processing of selections. In one specific form, the generation apparatus can be used independently of the selection apparatus. In one specific form, a new selection structure data element can be generated during the processing of selections.

The apparatus in accordance with claim 33 does not perform any database access operations during the processing of selections. In one specific form, the database access operations are performed when the, selection structure data element is, actually created. In another specific form, database access operations can be performed while the selection apparatus is active, in which case the results of database access operations influence further selections. This form can be used for selection apparatuses in accordance with claim 28.

The apparatus in accordance with claim 34 performs a maximum of one database access operation when processing a selection. In one specific form, results of database access operations are stored for the case of reusability.

The apparatus in accordance with claim 36 is used for identifying the effect of the data element when a selection description data element is created.

A rule makes a positive contribution to a selection if its condition part is satisfied. With a rule where the condition part describes a set of query data elements, this means that the available query data element belongs to the described set of query data elements. In one specific form, the apparatus displays the analysis data element as a table. In another specific form, the apparatus displays the analysis data element as a diagram. In one specific form, a plurality of display types can be chosen. Specific forms of the apparatus produce analysis data elements which also contain frequencies for satisfaction of the analysis details.

The apparatus in accordance with claim 38 is also used for ascertaining the effect of the selection function in addition to making the selection. To this end, a protocol data element can be created which contains the frequency of selection of output data elements. In one specific form, it logs rules which make a positive contribution. In one specific form, it logs rules without whose presence another selection was made.

The apparatus in accordance with claim 39 logs, when actuated appropriately, which rules in a selection have a satisfied condition part.

The apparatus in accordance with claim 40 contains a selection description device which can display a protocol data element which has been created by an apparatus in accordance with claim 38 or 39. In one specific form, the display is graphical. In one specific form, the display is in table form. In one specific form, a plurality of display types can be chosen.

The apparatus in accordance with claim 42 can be operated by various stations, which means that information is not accessible to all operators to the same degree. Operators of selection devices are not provided with the selection description data element. The selection structure data element does not contain the description in the form of the selection description data element, which means that the selection description data element cannot be created therefrom.

The apparatus in accordance with claim 43 can be operated such that operators of selection description devices are not provided with the input data elements. In one specific form, the selection description data element is created on the basis of profile components of the input data-elements. In another specific form, a description of the set of input data elements is available in the form a categorization.

The apparatuses in accordance with claims 1 to 43 can be used advantageously in various areas. Forms of the apparatuses in accordance with claim 44 are used for dynamically compiling contents of web pages. Dynamic compilation of contents of web pages means, that various calls to a web page do not always result in display of the same content. The compilation can be described by a selection description data element. In one form, the query data element contains information about the calling entity. In another form, the query data element contains information about circumstances of the station which is compiling the web page. The output data element determines the content of the web page. The content of a web page comprises structure information which is formulated in the language HTML, hypertext markup language. In one specific form, structure information for the web page is dependent on the output data element. It is possible for a web page to contain presentation information. One example of presentation information is color. In one specific form, presentation information is dependent on the output data element. It is possible for a web-page to contain text. In one specific form, text on the web page is dependent on the output data element.

It is possible for a web page to incorporate externally available components. One example of externally available components are diagrams.

In the case of the apparatus in accordance with; claim 45, the selection of externally available components is dependent on the output data element.

The apparatus in accordance with claim 46 is used to personalize e-commerce systems. In one specific form, the dynamic compilation of web pages contains a selection of offers matched to the customers. In one specific form, the dynamic compilation of web pages comprises a selection of offers which are influenced by the operator page of the e-commerce system. One example of offers influenced by an operator page are special offers. Another example are seasonal offers.

The apparatus in accordance with claim 47 ascertains weightings for query data elements. In one form, a numerical weighting is selected. In another form, one stage from a set of classifications is selected.

The apparatus in accordance with claim 48 can be used for targeted advertisement. The use of the apparatus protects data from the parties involved. Input data elements identify target units for the advertisement. In one specific form, these are addresses. Query data elements describe the advertisement contents. In one specific form, the advertisement contents are products. In another specific form, the advertisement contents are offers or lists of offers. In another specific form, the advertisement contents are brochures. The operator of the selection device has the input data elements available. The party initiating the advertisement creates the selection description data element without any knowledge of the contents of the input data elements. The operator of the selection device uses the selection structure data element to ascertain the selected input data elements. In one specific form, the operator of the selection device is not provided with the selection description data element. In one specific form, the operator of the selection device undertakes to carry out the advertisement. In another specific form, the party initiating the advertisement is provided with identifications for the, selected input data elements which it can use to carry out the advertisement. In one specific form, the party initiating the advertisement stipulates the selection structure data element by using an available selection structure data element which assigns advertisement contents to advertisement target descriptions. One specific form of the selection description apparatus converts the available selection structure data element such that it assigns advertisement target descriptions to advertisement contents.

### BRIEF DESCRIPTION OF THE DRAWINGS

FIG. 1 shows an apparatus comprising a generator apparatus and a selection apparatus which, when selection description data element and query data element are input, selects output data elements from input data elements.

FIG. 2 shows an apparatus which contains a preparation apparatus, processing apparatuses and data management apparatuses and connections, and also user apparatuses which are connected to processing apparatuses.

FIG. 3 shows a generator apparatus, a selection apparatus, two data management apparatuses and a changeover apparatus and also connections.

### DETAILED DESCRIPTION OF THE EMBODIMENT

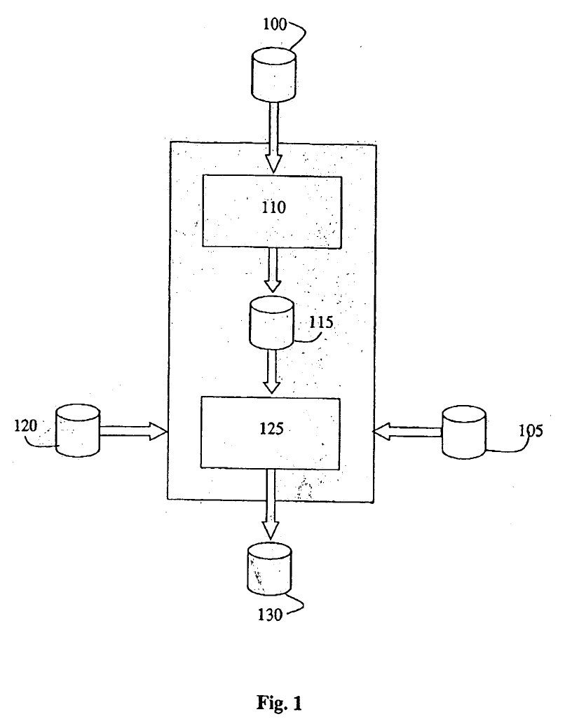

FIG. 1 shows an apparatus which contains a generator apparatus 110 and a selection apparatus 125. The generator apparatus 110 produces the selection structure data element 115 from the selection description data element 100. The selection apparatus 125 selects output data elements 130 from the input data elements 105 on the basis of a query data element.

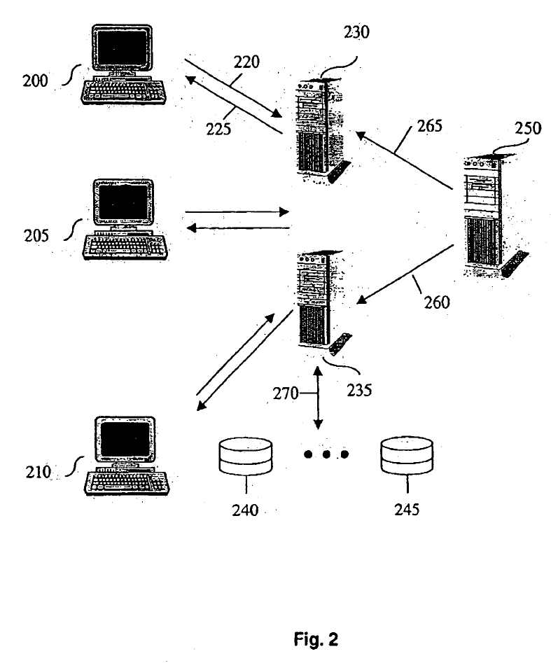

FIG. 2 shows an apparatus which contains a preparation apparatus 250, which itself contains a generator apparatus, and contains processing apparatuses 230 and 235, which themselves contain selection apparatuses, and data management apparatuses 240 and 245. The preparation apparatus 250 is connected to the processing apparatuses 230 and 235 by means of connections 260 and 265. The processing apparatuses are connected to the data management apparatuses 240 and 245 by means of a connection 270. The user apparatuses 200, 205, 210 are connected to the processing apparatuses. The user apparatus 200 is connected to the processing apparatus 230 by means of the lines 220 and 225.

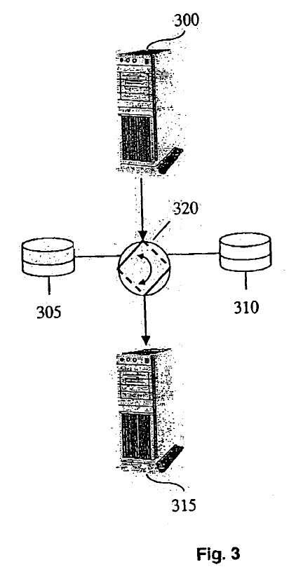

FIG. 3 shows a generator apparatus 300, a changeover apparatus 320, data management apparatuses 305 and 310 and a selection apparatus 315.

A technical form of the invention in accordance with claim 35 is described below. The apparatus contains three subsidiary apparatuses, a selection description, apparatus, a generator apparatus and a selection apparatus. These can be implemented separately from one another. For applications, a selection apparatus can be produced as an independent unit. They can also be combined in one apparatus or in two apparatuses, however. In one specific form, as shown schematically in FIG. 1, the generation apparatus and the selection apparatus can be produced in one apparatus in which they are connected. The connection can be in the form of a fixed connection. The connections can also be in the form of a detached connection which is set up as required.

The overall apparatus can contain more than one of each subsidiary apparatus. For many applications, an apparatus containing more than one selection apparatus is of particular advantage.

The apparatuses can be produced using universal computer systems. In particular, they can be produced using PCs. They can also be produced using special hardware. One example of special hardware is an apparatus which contains an ASIC. An apparatus can also be produced using nonspecialized hardware, such as FPGAs. One form uses replaceable storage media for the selection structure data elements. In one specific form, a selection apparatus is transportable. In one specific form, a selection device is a supplementary unit for a PC. In another specific form, a selection apparatus is contained in an independent apparatus.

The embodiment described is used to make a selection which, on the basis of the query data element containing the profile of the selections argument, makes a selection from the input data elements containing the profiles of the possible results, the selection structure data element containing a weighting for the input data elements, [lacuna] selects a profile with the maximum weighting. In another form, serial connection and/or other rule links and/or other cumulation operators can also be used.

Arguments and possible results can be addressed using a specific set of predicates. In this case, a predicate denotes a property. For an argument, the profile is stipulated by the sets of the predicates which it satisfies and the predicates which it does not satisfy. The result profile is stipulated by the sets of the predicates which it satisfies and of the predicates which it does not satisfy.

The function description contains rules. A rule can be described in the following form:

<argument description>→<result description> (weight) [1]

In this case, <argument description> is a Boolean expression relating to the argument predicates, <result description> is a Boolean expression relating to the result predicates, <weight> is a numerical variable. The above rule form is referenced by [1] in the text below. If the expression <argument description> is satisfied for an argument, the result objects denoted by result description> are weighted with <weight>. Other rule formats are possible besides.

Rules can be linked: by means of additive cumulation. If a plurality of rules then apply for an argument, then the weightings are added up. The selection is dependent on the resultant weightings. One selection option is maximization of the weighting. A result profile with the maximum weighting needs to be selected.

Rules are input using the selection description apparatus. In one particular form, this apparatus provides the user with input masks which can be used to input the left and the right side of a rule in the form [1] and its weight under syntax control. In another form, other masks can be produced. The rules can also be input character by character in some forms of the invention. In one particular form of the invention, the predicates can be selected from a menu which indicates the available options.

In one particular form, the rule analysis uses functions of the generator. Using, such operations, it is possible to calculate which rules can be used together, which are certain to exclude one another, whether all query data elements are recorded, which input data elements become the output data element for at least one query data element, and other properties. In particular, it is also possible to ascertain whether a rule has any influence on a result, and if so, for which arguments. In addition, the properties can also be quantified, i.e. can be expressed in absolute numbers or percentages. From a numbers, characteristic variables can then also be derived for a rule system. The rule editor allows the user to put these questions to the system and to have the results displayed to him in graphically processed form. In specific forms, various ones of these and other control, options are implemented. In addition the results can also be shown in table form. Rule systems can additionally be animated by evaluating arguments which have been selected randomly or which have been stipulated by the user. In this case, it is possible to display which rules were effectively involved in the selection or did not contribute to the maximum despite their having been used. In specific forms, various, ones of these and of other control options are implemented.

In one particular form, the generator makes internal use of a program package for processing. BDDs (Binary Decision Diagrams) and ADDs (Algebraic Decision Diagrams), the CUDD package (Colorado University Decision Diagram Package). In another form, other programs can be used. Presentation formats other than BDDs and ADDs can also be used. The left side of a rule in the form [1] is a Boolean expression which can be presented as a BDD. On the right side, the result predicates are regarded as Boolean expressions of binary coded results. It is then also possible to present a full: right side as a BDD using result coding bits. A conjunctive link of the two sides gives a BDD which describes the combinations of arguments and results for which the rule determines a positive weight. By multiplying by the weight of the rule, an ADD is obtained which expresses this weight association. If the ADDs for all the rules are added, then the result is the desired, cumulated weight association. For the described object of maximum association, a structure containing one (or some, or all, according to requirements) results with maximum weighting for each argument profile is extracted from the ADD. This is then the evaluation structure. In another form, the evaluation structure data element also contains result profiles with lower than maximum weighting. Depending on application requirement, result profiles in the selection structure data element can also be replaced by output data elements themselves or by references to output data elements. In some forms, this influences the need for database queries. If database queries are necessary from time to time, then buffer-storage of request results can be used to reduce the number of requests.

In the form with ADDs, the evaluation structure is a directional, acyclic diagram with a degree of branching of two in which the argument predicates appear in a fixed order on every path. At the end of every path is a result or a reference to the result. The evaluation apparatus receives, for each argument, the binary profile, from which it is possible to read which branch on an internal node of the evaluation structure needs to be selected. Since a predicate occurs a maximum of once on each path, a, request can be answered in linear time in the number of argument predicates, regardless of the number of rules. Alternative forms of the generation give selection structure data elements with differing characteristics.

For logging, in one form, the generator can produce additional structures. In another form, the selection structure, data elements can be extended by information. The further information includes which rules have acted, for an, argument and which contributed to the, decision. This can have a statistic creased for it which logs the frequency of these results. In particular instances of application information, about the success of, a selection decision s, available. In one particular form, such information can be utilized. In one form, the success information is calculated back to the responsible parts of the selection description data element. In another form, success weightings for the selection description data element are calculated.

Logging requires additional processing time, which is dependent on the accuracy of the chosen observations and, in the case of some observations, on the number of rules. Hence, in particular forms, logging can be added and disconnected dynamically on the basis of the load on the computer system.

Description of Another Embodiment

Computer components which perform functions within other devices are called embedded systems. An example of a function which can be performed by an embedded system is control of the ignition time in the engine of a car. Another example is the control in an analog or digital camera. Another example is the control unit in a mobile telephone. Embedded systems frequently need to satisfy real-time requirements while resources are simultaneously scarce, partly for economic reasons and partly for technical reasons. Thus, the invention can be used advantageously in this area when the necessary scope of function can be implemented in the manner described.

In one implementation, the embedded system contains a selection apparatus. In one specific form, the selection apparatus is implemented on an information-processing chip. In another form, the selection apparatus can be added to the rest of the embedded system in modular fashion. In specific instances, the selection apparatus is the control unit in the embedded system. In an even more specific instance, the embedded system comprises a selection apparatus with selection structure data element and connected peripherally devices for making the inputs available and for activating the outputs.

The selection structure data element can be implemented on the same chip as the selection apparatus. Alternately, it can be implemented on a separate chip. In one specific form, the selection structure data element can be altered. In another form, the selection structure data element can be implemented on replaceable storage media. In another form, the selection structure data element is loaded on a static memory.

Functions of a discrete nature can be performed by a selection apparatus. Functions which have numerically intensive components can be performed by a selection apparatus in the discrete parts. The selection of numerical calculations is a discrete part. One form of implementation comprises an initial stage apparatus which puts the arguments into discrete form, a selection apparatus which, adopts the discrete arguments as a query data element and creates the output data elements, and an elements and produces the control values which are forwarded to the controlled system. In this case, the implementation options is to evaluate numerical conditions in the initial stage apparatus and to perform numerical calculations at that time. And the implementation option, is also, to perform numerical calculations in the output stage apparatus. Depending on the type of application, implementation is also possible without initial stage apparatus or output stage apparatus.

Description of Another Embodiment

When personalizing web pages and Internet applications, the contents of web pages need to be compiled not on a statically fixed basis but rather on a case-by-case basis. In this context, selection apparatuses in accordance with one of claims 22 to 30 can be advantageously used. One advantage relates to the speed at which the selection apparatus makes selections. The speed reduces the server load. The speed also reduces the time, required for showing a page to the person calling it. Another advantage relates to the selection device's implementability, which can be limited to simple operations.

With cumulatively linked rules, selections for components of web pages can be formulated. Other, rule structures can also be used. The conditions on which the selections depend can contain user specifics. They can also include prior user behavior. They can also include environmental conditions, current situations in the outside world and criteria set by the operator of the application. Structure and, form parameters for web pages can likewise be formulated. The selection of a plurality of components of a page is an example of a more complex selection function for which serial connection can be put to appropriate use. In one specific form, the selection structure data element can be approximated for the serial connection by virtue of association diagrams for the components containing some of the possible results with high weightings, and the selection of the compilation being stipulated in a downstream part. Another application for serial connection is obtained when selections are matched to one another and are made, at different times for the same user. One specific form of the system is able to reduce the selection complexity for multiple selections with in some cases identical query data elements by using interim results.

In one specific form, the system has the opportunity to perform prior calculations for selections which are potentially required later. In one specific form, this is coupled to the availability of resources.

FIG. 2 shows one possible implementation of a system. In this case, the processing apparatuses 230 and 235 contain selection apparatuses. The processing apparatuses process queries from the user apparatuses 200, 205 and 210. In this case, the database apparatuses 240 and 245 can be accessed via the connection 270. In one form, the output data elements are stored in 240 and 245. In another form, they are contained in the processing apparatuses. The preparation apparatus 250 can be implemented on a plurality of computers. It can also contain selection description and/or analysis apparatus. The selection apparatuses can be implemented on a server farm. Alternatively, they can be implemented by separate devices. The overall personalization system can be in the form of a module which can be added to other application systems.

In comparison with, conventional personalization systems, which operate with databases, the invention can be implemented without using databases. Even when data management apparatuses are situated outside of the processing apparatuses, database applications are not necessary in many kinds of application. Hence, the architecture of a personalization system [lacuna] with the invention changes as a result of the omission of a database server or a reduced size of the database server or a smaller size and different architectonic incorporation of the database server.

Description of Another Embodiment

In targeted marketing, the aim is to select potential customers who are then addressed with greater prospects of success than in the case of randomly scattered advertizing. A prerequisite is always a database storing information about customers. The invention can be used advantageously in this area in different variants.

First, the rule formats provide description means that can be used to formulate associations and weightings between customers and products. One particular advantage in this context is that they can also be used by marketing specialists who have no special knowledge about databases. The rule analysis options are also useful in this connection.

A technical advantage is also that rules which assign products or product weightings to customers or customer profiles can be interpreted in the opposite direction. By way of example, the evaluation structures can also be in a form such that products or product profiles are assigned to customers. Utilizing this selection option can simplify the creation of the descriptions. Any desired intermeshing of customer and product profiles can also be used in the descriptions. Another benefit is obtained when an existing, e.g. for some time tried-and-tested, rule set which recommended products to customers (that is to say was used for product selection) can now be used, possibly having been extended, for selecting customers.

The use of evaluation structure data elements and selection apparatuses also makes it possible to take into account data protection aspects and the protection of proprietary knowledge in a very extensive form. Thus, to create evaluation structure data element and selection apparatus, it is not necessary to know the specific data records without impairing the process. Structure and evaluator can also be created entirely without access to the database. Thus, it becomes possible for undisclosed data to be used for targeted marketing. In one possible implementation, a user creates a rule set and produces evaluator and evaluation structure therefrom. The station which has the database undertakes extraction of the data records and sending of the advertisement. The data records themselves thus remain secret. Additionally, the user can also keep his rule set secret, since it cannot be created again from the evaluation structure. Even in other forms of the system, information having a lateral or unilateral protection is features which are also relevant to applications.

Description of Another Embodiment

FIG. 3 sketches the architecture of a form of a system with a selection apparatus in accordance with claim 23. The data management apparatuses 305 and 310 can each hold a selection structure data element. At a time, the selection apparatus 315 has access to one of the two data management apparatuses. The generator apparatus 300 has access to the other data management apparatus. Access is controlled by means of the changeover element 320 shown in symbol form. In this way, the selection structure data element can be updated without interrupting ongoing operation. The architecture can also be implemented with a plurality of selection apparatuses.

Implementation is possible in various technical forms. In particular, special hardware can be used. The changeover apparatus can also be implemented within one of the other apparatuses.

List of Other Application Areas

Other application areas are

Personalized advertisement, for example in the area of e-commerce (electronic commerce) (both B2B, B2C and C2C) or m-commerce (mobile commerce)

Auction platforms

Personalized, situation-dependent organization of workflows

Personalized online newspapers and other information services, particularly where there is great call for them to be up-to-date, such as stock market services

Tailored support in teaching/learning environments

Diagnostic support and diagnostic systems in any area (e.g. vehicle electronics, medicine)

Matching services and intelligent search engines

Customer services and customer care

Data mining

Search systems implemented in hardware or firmware

Conveying and consultancy systems, for example in trade or in the insurance business

User guides (e.g. in consumer electronics)

Knowledge management systems

General coordination or control systems (e.g. process control and monitoring., warning systems, emergency controllers, disaster management)

Planning systems (e.g. layout design, workflow or phase planning),

Decision support systems. These also include systems which can be used for security checks. In one specific form, a selection apparatus creates a risk assessment. In one specific form, a security specialist creates a selection description data element for weighting. The generated selection structure data element can be used for risk assessment in situ. In this case, in one specific form, the selection description data element remains secret.

Range structure and selection

Offer compilation (bundling)

Warehouse administration

Marketing design and implementation

Customer behavior and market analysis

Profile supported decision systems (decision support systems)

Anamnesis assistance

Channel allocation for mobile radio.

In these or in other application scenarios,

the overall concept,

the core concept of the generator/evaluator solution,

evaluation structures or

the concept of control systems with or without analysis can be usefully used alone or in combination to increase efficiency or for the purpose of suitable modeling.

The implementation can respectively be effected using special hardware or using a hardware/software codesign or using software on standard hardware.

1. A selection description device for creating a selection data element, characterized in that
rules and rules compiled using links can be formulated as parts of the selection data element,
rules contain a condition part and a conclusion part.

2. The apparatus as claimed in claim 1,
where rules contain a numerical component.

3. The apparatus as claimed in claim 1 or 2,
where rules can be created
in which the condition part describes a set of, query data, elements and the conclusion part describes a set, of input data elements.

4. The apparatus as claimed in claim 2 or 3,
where rules can be linked by means of cumulation.

5. The apparatus as claimed in one of claims 1, 2, 3, 4, where rules can be linked by means of serial connection.

6. The apparatus as claimed in claim 5,
where output data elements of upstream rules can contain actions which are intended for execution before the evaluation of downstream rules.

7. The apparatus as claimed in one of claims 1, 2, 3, 4, 5, 6,
where rules can be linked by means of prioritization.

8. The apparatus as claimed in claim 4,
where, for an output data element comprising a plurality of components,
rules linked by means of cumulation, can be used for each, component
rules can be connected downstream for the combination of the components in the output data element.

9. The apparatus as claimed in claim 8,
[lacuna] results of earlier selections can be referenced in rules.

10. The apparatus as claimed in one of claims 1, 2, 3, 4, 5, 6, 7, 8, 9,
where rules can be formulated such that a part which is used in more than one rule is not written in each of these rules.

11. The apparatus as claimed in claim 10,
where macros for rule parts can be defined and used.

12. The apparatus as claimed in one of claims 10, 11,
where a rule part can be used for indicating a plurality of rules.

13. A generator apparatus for producing a selection structure data element from a selection description data element,
where
the selection description data element describes the selection of output data elements from input data elements on the basis of a query data element,
the selection structure data element is an association diagram conglomerate which denotes the selection which is described by the selection description data element.

14. The apparatus as claimed in claim 13,
which can be controlled using control input elements,
[lacuna] that it produces a selection structure from the selection description data element, where
the selection structure produced makes the selection described by the selection description data element on an approximative basis,
the selection structure produced is smaller than that selection structure which makes the selection exactly and which would be produced by the apparatus without the special controller,
the size of the selection structure produced is controlled by the control input elements.

15. The apparatus as claimed in claim 14,
where the selection includes the calculation of cumulative numerical weighting functions which calculates with an accuracy determined by control input elements when calculating numerical weightings.

16. The apparatus as claimed in one of claims 14, 15,
where the selection process has a plurality of stages,
which apparatus represents the results of a preceding stage incompletely in the selection structure and produces a selection structure of relatively small size as compared with a full representation.

17. The apparatus as claimed in one of claims 13, 14, 15, 16,
which changes a selection, structure produced for a selection description data element when the selection description data element changes such that the changed selection structure corresponds to the changed selection description data element without any recalculation being performed and saves time as compared with any recalculations.

18. The apparatus as claimed in one of claims 13, 14, 15, 16, 17,
which uses minimized association diagram structures in order to produce the selection structure.

19. The apparatus as claimed in claim 18,
where the minimized association diagram structures have a binary degree of branching.

20. The apparatus as claimed in claim 19, which uses ADDs.

21. The apparatus as claimed in one of claims 13, 14, 15, 16, 17, 18, 19, 20,
where the selection description data element describes the selection using weighting functions of the input data elements on the basis of the query data elements,
characterized in that
a selection, description data element has a selection structure produced for it which selects for an input data element those query data elements for which the input data element is given the highest weighing.

22. A selection device for selecting output data elements from input data elements on the basis of a selection structure and a query data element,
where
the selection structure is an association diagram conglomerate.

23. The apparatus as claimed in claim 22,
which can access more than one selection structure,
where a selection structure can be replaced without interrupting ongoing operation.

24. The apparatus as claimed in one of claims 22, 23,
which has the opportunity,
during a query whose query data element is the same as that for an earlier query in some components, to use interim results which come from earlier query processing operations.

25. The apparatus as claimed in one of claims 22, 23, 24,
which can be controlled such
that, during a query processing operation, it can choose at random from a plurality of possible selection results.

26. The apparatus as claimed in one of claims 22, 23, 24, 25,
where the selection results can be altered without replacing the selection structure.

27. The apparatus as claimed in one of claims 22, 23, 24, 25, 26,
which is capable, during multistage selection processes,
where actions can occur in the results of preceding stages, of performing actions during the selection process.

28. The apparatus as claimed in one of claims 22, 23, 24, 26, 27,
which is connected to apparatuses for ascertaining query data elements and to apparatuses which convert output data elements into actions.

29. The apparatus as claimed in one of claims 22, 23, 24, 26, 27, 28,
within an apparatus for controlling a process of the physicochemical type.

30. The apparatus as claimed in one of claims 22, 23, 24, 25, 26, 27, 28
in the application for calculating weighting functions.

31. An apparatus which comprises a generator apparatus as claimed in one of claims 13, 14, 15, 16, 17, 18, 19, 20, 21 and a selection apparatus as claimed in one of claims 22, 23, 24, 25, 26, 27, 28, 29, 30.

32. The apparatus as claimed in claim 31,
where
a generator apparatus can operate offline,
the selection apparatus can operate online.

33. The apparatus as claimed in claim 32,
where
the output data elements come from a database,
the apparatus does not perform, any database access operations during a selection operation.

34. The apparatus as claimed in claim 32,
where
the output data elements come from a database,
the apparatus performs a maximum of one database access operation during a selection operation.

35. An apparatus which contains an apparatus as claimed in claims 31, 32, 33, 34 and an apparatus as claimed in claims 1, 2, 3, 4, 5, 6, 7, 8, 9, 10, 11, 12.

36. The apparatus as claimed in claim 4,
which creates for a selection data element an analysis data element,
displays the analysis data element as a table and a graphic,
the analysis data element contains
for which input data elements query data elements exist, so that they are chosen as output data elements,
for which rules of the selection data element query data elements exist, so that the rules make a positive contribution to a selection.

37. The apparatus as claimed in claim 36,
where the analysis data element contains
for which rules it provides query data elements for which the output data element would change if the rule were removed from the selection data element.

38. The apparatus as claimed in claim 22,
which creates for a succession of selections a protocol data element which contains the, frequency of the selection of output data elements.

39. The apparatus as claimed in claim 31 with a selection apparatus as claimed in claim 38,
characterized in that
the presence of cumulatively linked rules in a selection description data element causes the selection apparatus to be able to be controlled such
that the protocol data element contains which of the cumulatively linked rules were involved in a selection.

40. The apparatus as claimed in claim 39 with a selection description apparatus as claimed in claim 4, characterized in that
the selection description apparatus can be used in order to display the protocol data element.

41. An apparatus which contains an apparatus as claimed in claim 32 and an apparatus as claimed in claim 4.

42. The apparatus as claimed in claim 41,
where
the selection apparatus can be operated separately from a generator apparatus and from the selection description apparatus,
the selection apparatus has no access to selection description data elements,
the generator apparatus and the selection description apparatus have no access to query data elements.

43. The apparatus as claimed in claim 41,
where
the selection description device can be operated separately from the generator device and the selection device,
the selection description device has no access to contents of the input elements.

44. The apparatus as claimed in claim 35,
where the output data elements determine the compilation of contents of web pages.

45. The apparatus as claimed in claim 35,
where the output data elements denote components of web pages.

46. The apparatus as claimed in claim 35,
which provides personalization functions in connection with an e-commerce system.

47. The apparatus as claimed in claim 42,
where the output data elements are weightings of the query data elements.

48. The apparatuses as claimed in claim 43,
where the output data elements determine targets of advertisement.
